(19) United States
(12) Patent Application Publication
(10) Pub. No.: US 2016/0082365 A1
(43) Pub. Date: Mar. 24, 2016

(54) DEVICE FOR FORCED DRAINAGE OF A MULTIPHASE FLUID

(71) Applicant: FONDS DE L'ESPCI - GEORGES CHARPAK, Paris (FR)

(72) Inventors: VINCENT MIRALLES, IVRY SUR SEINE (FR); ISABELLE CANTAT, RENNES (FR); BERTRAND SELVA, BEAUVILLE (FR); JULIEN MARCHALOT, VILLEURBANNE (FR); MARIE-CAROLINE JULLIEN, PARIS (FR)

(21) Appl. No.: 14/890,914

(22) PCT Filed: May 13, 2014
(86) PCT No.: PCT/FR2014/051115

§ 371 Date: Nov. 13, 2015

(30) Foreign Application Priority Data
May 13, 2013 (FR) 1354252

(51) Int. Cl. B01D 17/00; B01F 15/06; B01F 3/04; B01F 3/22; B01D 19/00; B01D 17/04

(52) U.S. Cl. CPC B01D 17/005; B01D 19/0073; B01D 17/042; B01F 3/04992; B01F 3/22; B01F 15/066; B01F 2015/062

(57) ABSTRACT

A device for configuring a multiphase fluid consisting of at least two immiscible phases on either side of separation surfaces. A chamber to contain a multiphase fluid. A temperature gradient generator to generate a temperature gradient along the chamber to vary the surface tension of the separation surfaces along the chamber and to cause at least one of the phases of the multiphase fluid to move. An extractor to extract the multiphase system. Preferably, the temperature gradient generator includes at least one electrical resistor formed on the surface of the chamber to provide a variable heat density along the wall of the chamber.

### TECHNICAL FIELD OF THE INVENTION

The present invention relates to a device for forced drainage of multiphase fluids. It applies in particular to the field of industrial foams, bubbly liquids and emulsions.

### BACKGROUND OF THE ART

Multiphase fluids consist of at least two immiscible phases on either side of separation surfaces. Multiphase fluids comprise, in particular, foams, bubbly liquids and emulsions. Foams are involved in numerous industrial processes, in the form of liquids, such as shampoo, or beer, or in solid form, such as metal foams or chocolate foams. These materials have long been studied and characterized.

Structured foams are of great interest in many fields, such as, for example:
metal foams, for their high mechanical resilience;
catalysts, for their high surface-to-volume ratio; and
phononic materials, for their ability to absorb sound.

One of the major difficulties in manufacturing these materials concerns controlling the changes in the foam before it solidifies. In contrast, other applications require destabilizing foams produced as part of industrial processes, such as wastewater treatment.

Changes in the foam depend on three phenomena:
drainage due to gravity, which brings about a gradient in the liquid fraction (the proportion of liquid being higher in the lower portion of the foam);
diffusion of gas through the liquid films leading to a reduction in the number of bubbles and an increase in their dimensions; and
coalescence, i.e. the merging of neighboring bubbles.

Recent publications show that controlling these changes is a critical question in many fields of application (see for example A.-L Fameau, A. Saint-Jalmes, F. Cousin, B. Houinsou Houssou, B. Novales, L. Navailles, F. Nallet, C. Gaillard, F. Boué, and J.-P. Douliez. “Smart foams: Switching reversibility between ultrastable and unstable foams”. Angew. Chem., 50, 8264-8269, 2011; D. E. Moulton and J. A. Pelesko. “Reverse drainage of a magnetic soap film.” Phys. Rev. E., 81, 046320, 2010 and E. Chevallier, C. Monteux, F. Lequeux and C. Tribet. “Photofoams: remote control of foam destabilization by exposure to light using an azobenzene surfactant.” Langmuir, 28, 2308-2312, 2012.

Methods are known for draining the liquid phase of a foam by blending materials into the foam, such as magnetic particles or photosensitive or heat-sensitive surfactants.

However, in addition to their costs, these materials pollute the foam and may modify certain physical, chemical or physicochemical properties.

### SUMMARY OF THE INVENTION

One of the aims of the present invention concerns the possibility of controlling the drainage of the foam by applying a temperature gradient in the foam.

According to a first aspect, the present invention relates to a device for configuring a multiphase fluid consisting of at least two immiscible phases on either side of separation surfaces, which comprises:
a chamber containing a multiphase fluid,
means for generating a temperature gradient along the chamber in order to vary the surface tension of the separation surfaces along the chamber and to cause at least one of the phases of the multiphase fluid to move, and
means for extracting the multiphase system.

The inventors have discovered that the thermocapillarity forces cause the drainage of a phase, liquid for example, at a relatively high velocity. For example, for a foam with an initial liquid fraction of 35%, the device that is the subject of this invention makes it possible to drain 70% of the liquid phase in under 30 seconds.

It should be noted that the multiphase system can comprise at least one liquid phase or at least one gas phase.

In the case of applications of the invention to a monolayer of bubbles placed in a system extending substantially in two horizontal dimensions, there is also the benefit of the absence of gravity drainage along two adjacent bubbles, since only thermocapillary drainage operates in this configuration.

In some embodiments, the means for generating a temperature gradient comprises at least one electrical resistor formed on the surface of the chamber in order to provide a variable heat density along the wall of the chamber.

The benefit of this means for generating a temperature gradient is to have a very short transient time.

In large-scale applications, the temperature gradient can be generated on the edges of a chamber via various techniques for heating (Joule effect, pre-heated fluids, microwaves, etc.). The difference lies in the transient time for establishing the temperature gradient. For example, on a one-meter scale, several tens of minutes will be required for a conventional material (conductive metals such as copper).

In some embodiments, the device that is the subject of the present invention comprises means for generating the multiphase fluid upstream from the chamber.

In some embodiments, the device that is the subject of the present invention comprises means for generating the multiphase fluid inside the chamber.

In some embodiments, the means for generating the multiphase fluid is configured to provide foam.

In some embodiments, the means for generating the multiphase fluid is configured to provide a bubbly liquid.

It is recalled here that a bubbly liquid is a liquid in which bubbles are mostly not joined with the neighboring bubbles.

In some embodiments, the means for generating the multiphase fluid is configured to provide an emulsion.

In some embodiments, the device that is the subject of the present invention comprises means of solidifying the multiphase fluid.

In some embodiments, the means for generating a temperature gradient along the chamber to cause a displacement of at least one of the phases of the multiphase fluid is configured to remove half of one of the phases of the multiphase fluid from the chamber.

This is the case of an open chamber without an upstream liquid tank.

In some embodiments, the means for generating a temperature gradient along the chamber to cause a displacement of at least one of the phases of the multiphase fluid is configured to humidify the multiphase fluid by increasing the proportion of liquid, in the case of foams, from a tank positioned upstream.

This is the case of an open chamber with an upstream liquid tank.

In some embodiments, the means for generating a temperature gradient along the chamber to cause a displacement of at least one of the phases of the multiphase fluid is configured to homogenize the distribution of the phases of the multiphase fluid, within the chamber.

These embodiments apply to open chambers, to closed chambers and particularly to the case wherein at least one of the phases is subject to the effect of earth's gravity, by counteracting this effect with the thermocapillary effect.

In this way a continuous production run is achieved of, e.g. homogenized foam, destabilized foam or elastomer comprising uniformly distributed bubbles.

According to a second aspect, the present invention relates to a method for configuring a multiphase fluid consisting of at least two immiscible phases on either side of separation surfaces, which comprises:
a step of forming a chamber full of multiphase fluid,
a step for generating a temperature gradient along the chamber in order to vary the surface tension of the separation surfaces along the chamber and to cause at least one of the phases of the multiphase fluid to move, and
a step for extracting the multiphase system.

As the particular features, advantages and aims of this method are similar to those of the device that is the subject of the present invention, they are not repeated here.

### BRIEF DESCRIPTION OF THE FIGURES

Other advantages, aims and features of the invention will become apparent from the description that follows of at least one particular embodiment of the device and the method that are the subjects of the present invention, with reference to drawings included in an appendix, wherein:

FIG. 1 represents, schematically, a particular embodiment of the device that is the subject of this invention;

FIG. 2 represents, in a photograph, the travel of a control particle within the device illustrated in FIG. 1 as it follows the thermocapillary flow;

FIGS. 3a and 3b represent respectively a curve representing a temperature gradient and a curve representing a matching temperature profile along a longitudinal axis of a chamber illustrated in FIG. 1;

FIGS. 4 and 5 represent, in photographs, foams at the beginning of and during the operation of the device that is the subject of the present invention, showing the decline of the liquid fraction;

FIG. 6 represents, over time, the change of the volumetric fraction of the liquid phase in the device illustrated in FIG. 1;

FIG. 7 represents, over time, a change in the number of bubbles in the device illustrated in FIG. 1;

FIG. 8 represents, in photographs, the motion of a control particle within the device illustrated in FIG. 1, with a vertically-positioned chamber;

FIG. 9 represents, as a logic diagram, steps of particular embodiment of the device illustrated in FIG. 1 and of its operation;

FIG. 10 represents, schematically, a particular embodiment of the present invention, within a three dimensional foam;

FIG. 11 represents, schematically, a foam production line configured by utilizing the present invention;

FIG. 12 represents, as a series of dots and interpolation curves, the changes over time of liquid fractions in three configurations; and

FIG. 13 represents, as a series of dots and interpolation curves, a comparison between a model and results of experiments.

### DETAILED DESCRIPTION OF THE EMBODIMENTS OF THE INVENTION

It is now noted that the figures are not to scale.

Generally speaking, the invention concerns controlling the drainage of multiphase fluids, e.g. foams, by applying a temperature gradient in this foam. Multiphase fluids consist of at least two immiscible phases on either side of separation surfaces or interfaces. The temperature gradient causes a surface tension gradient of the bubbles, known as the “Marangoni effect”.

The description mainly describes an embodiment of the present invention applied to a two-dimensional foam, i.e. where the foam is made of a monolayer of bubbles positioned between two plates separated by a distance that is at least and preferably an order of magnitude smaller than the other dimensions. In addition, the thickness of the foam corresponds to the vertical axis, which reduces the effect of gravity, in contrast with cases where one of the other dimensions is vertical. However, this invention is not limited to applications with two-dimensional foams but extends, on the contrary, to all configurations of multiphase fluids, foams, bubbly liquids and emulsions likely to be subjected to a temperature gradient and, in some configurations, to gravity.

Focus will be placed below on a two-dimensional foam in micro-confinement, i.e. located between two parallel plates separated by a gap of at least 100 microns, for example approximately 30 microns.

Studies of two-dimensional foam have been widely analyzed both theoretically and experimentally since Plateau's first experiments in 1873. The advantage of studying two-dimensional foams comes in particular from the absence of gravitational drainage if the two plates forming the chamber are positioned horizontally. On a scale of a millimeter or greater, the geometry of a dry foam consists of bubbles separated by films with a height substantially equal to the height of the gap separating the two plates. In this case, there is general agreement between theory and experience on the aging of foams, which is essentially governed by Von Neumann's law, linked to the diffusion process of gases through films, as specified in the introduction. On a micrometer scale, Von Neumann's law is still observed with an effective diffusion coefficient approximately one order of magnitude smaller than on a millimeter scale.

The inventors have shown that this divergence is a result of the geometry of the two-dimensional micro-foam: even though the foam has the geometry of a dry foam in the observation plane, it has a humid structure in the transversal plane (presence of a line of contact instead of a film between two adjacent bubbles).

In the rest of the description, a system is presented, which is able to force the drainage of the liquid phase by using a thermocapillary stress. This thermocapillary stress is generated by applying a temperature gradient, preferably constant, i.e. with a constant drift of the temperature according to the distance traversed along a longitudinal axis of the chamber.

In some embodiments, an optimized pattern of resistors provides a high temperature gradient with a linear profile. This pattern is described in the following publications:

B. Selva, J. Marchalot, M.-C. Jullien. “An optimized resistor pattern for temperature gradient control in microfluidics.” Journal of Micromechanics and Microengineering, 19, 065002, 2009 and

V. Miralles, A. Huerre, F. Malloggi, M.-C. Jullien. “A review on heating and temperature control in microfluidic systems: techniques and applications.” MDPI Diagnostics, 3, 33-67, 2013.

In the device that is the subject of the present invention, the thermocapillary forces generate a high-velocity forced drainage of the liquid phase of the foams (millimeter-scale velocity in a microfluidic channel): for a foam with a 35% initial liquid phase, more than 70% of the liquid phase was drained in less than 30 seconds. Therefore, it is possible to have effective and fast control of the liquid fraction of the foam, simply by using a temperature gradient.

The description of a particular embodiment of the device that is the subject of the present invention follows.

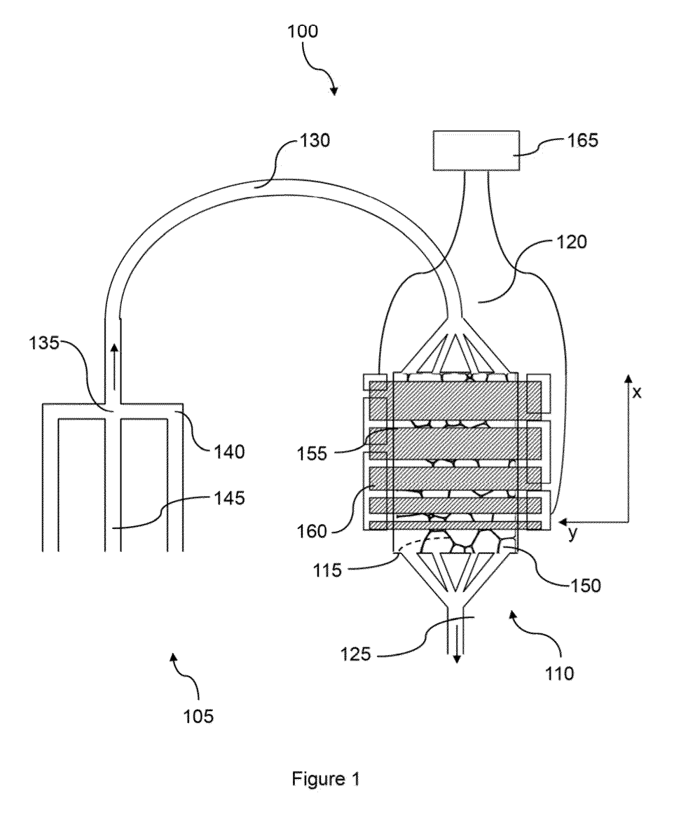

As illustrated in FIG. 1, this device 100 comprises two parts:

a flow focusing system 105 generating bubbles; and

a chamber 110 comprising a static foam 115, between an inlet 120 and an outlet 125.

The system 105 and the chamber 110 are connected by a capillary tube 130.

The system 105 is described, for example, in the publication by A. M. Ganan-Calvo and J. M. Gordillo: “Perfectly monodisperse microbubbling by capillary flow focusing”, Phys. Rev. Lett., 87 2001 274501.

The system 105 for focusing flows comprises an intersection 135 through a channel 140, in which the continuous phase enters from either side of a dispersed phase inlet 145. Garstecki et al. (P. Garstecki, M. J. Fuerstman, H. A. Stone, G. M. Whitesides. “Formation of droplets and bubbles in a microfluidic T-junction-scaling and mechanism of break-up.” Lab Chip, 6, 437-446, 2006.) have shown that the dispersity of the size of bubbles generated by this procedure can be controlled by different flow rates for liquids and gas.

The chamber 110 produced, for example, by soft lithography, carries on at least one wall 150, a resistor 155 produced, for example by lithography. The procedure for making a microsystem using soft lithography is detailed in Y. Xia and G. M. Whitesides, “Soft Lithography”, Angew. Chem., Int. Ed., 37 1998 550.

The resistors 155 and the electrical connections 160 are produced by evaporation of, respectively, chromium (15 nm, heating resistor) and gold (150 nm conductive resistor) on a wafer, then etched by using a photosensitive resin (Microposit S1818, registered trademark) after ultraviolet exposure through a mask. The etching involves two steps: (i) the first creates a connection between the heating resistors and the current generator (made of gold: high electrical conductivity with a negligible Joule effect) and (ii) the second step comprises the production of the optimized resistors in chromium.

As illustrated in FIG. 1, the resistors 155 are orthogonal to the main direction of the chamber 110, represented by an arrow on the right of FIG. 1. This arrow is oriented along the temperature gradient. It can be seen that the cross-sections of the resistors 155 decrease from the top to the bottom in FIG. 1. In this way, the heating of the highest resistor 155 shown in FIG. 1 is less than that of the next resistor and so on until the last resistor 155, shown lowest in FIG. 1.

Gold connectors 160 are fitted to each extremity of each resistor 155. A current generator 165 is connected to the connectors 160.

The temperature gradient obtained with the resistors 155 is constant along the 2.5 mm length of the cavity, as illustrated in FIG. 3b. The heating resistors 155 are electrically insulated by a thin coating. For example, this thin coating is a 40-micron thick Polydimethylsiloxane (PDMS) coating.

In the experimental embodiment, a Hele-Shaw cell, 45-micron high, 1.5 mm wide and 2.5 mm long in the horizontal plane, made of PDMS is then sealed onto the wafer containing the heating resistors by using an air or oxygen plasma, to form the chamber 110.

The multiphase fluids are made of at least two immiscible fluids. In the proposed embodiment, the air bubbles generated in the flow focusing system 105 are introduced into the chamber 110 through the capillary tube 130. The liquid phase consists of, for example, deionized water (91.04% by mass), glycerol (5.68% by mass), an anionic surfactant (SDS 0.26% by mass) and titanium dioxide (3.00% by mass).

Consequently, the concentration of surfactant is 9 mmol/L, which is just above the critical micelle concentration (CMC of approximately 8 mmol/L at 20° C.). The surface tension of the solution with air was measured using the Wilhelmy plate method at a value of 30.2 mN.m⁻¹ at 25° C. The temperature dependence dγ/dT is assessed at −2.06 10⁻⁴ N.m⁻¹.K⁻¹, using the same method as described in the document B. Selva, J. Marchalot, M.-C. Jullien: “An optimized resistor pattern for temperature gradient control in microfluidics.” Journal of Micromechanics and Microengineering, 19, 065002, 2009, incorporating a constant-temperature bath.

The constant-temperature bath is a commercial device (for example from “Julabo”, registered trademark) that makes it possible to regulate the temperature of a liquid contained within a chamber. It consists of a chamber, a heating resistor and a thermocouple providing closed-loop control of the temperature of the liquid contained in the chamber. To measure the surface tension, the two fluids are placed in a vat, called “measurement vat”, in which the Wilhelmy plate is immersed. This vat contains chamber-walls in which a liquid can circulate. A pump fitted with connectors enables the transport of the temperature-controlled liquid towards the measurement vat's chamber-walls, thus making it possible to control the temperature of the two phases contained in the measurement tank.

When the bubbles completely fill the chamber 110, a static foam is produced in the chamber, either by disconnecting the capillary tube or by stopping the flow of foam that its transports. In the first case, the pressure at both the inlet and the outlet of the chamber 110 is equal to the atmospheric pressure, i.e. no pressure gradient is applied along the chamber 110. In addition, there is no liquid tank upstream of the flow initiated in the continuous phase of the foam, which causes the foam to dry when draining. The current generator that supplies the resistors 155 via the electrodes 160 is then switched on to apply a longitudinal temperature gradient within the chamber 110.

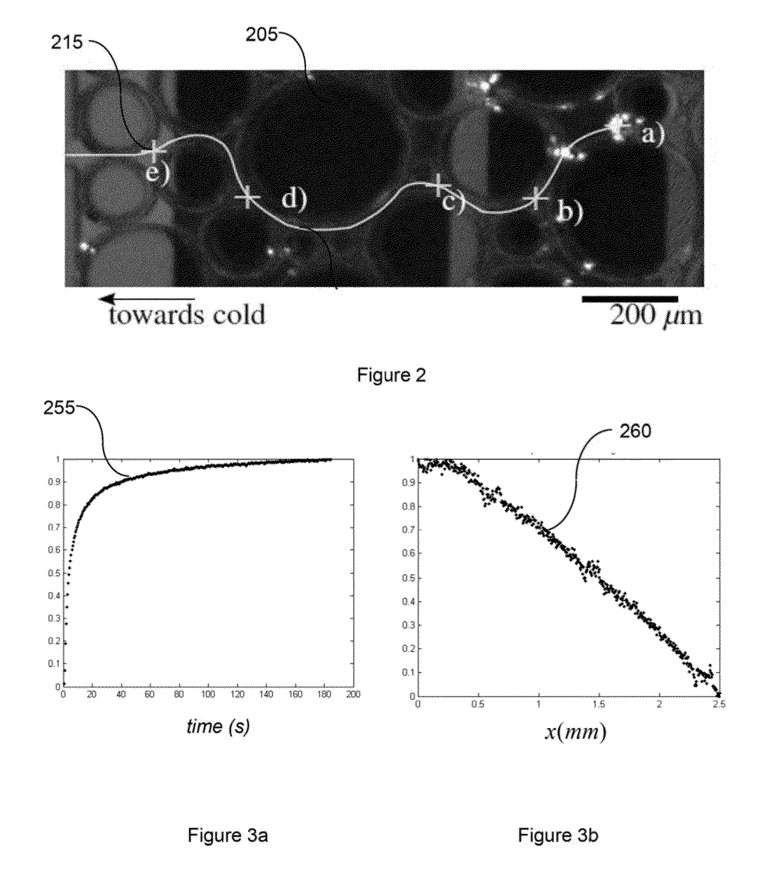

The velocity of the continuous phase (the liquid phase in this case) within the foam, to which a temperature gradient is applied, was estimated by incorporating particles with very small dimensions into the foam, and following their travel over time. FIG. 2 represents bubbles 205 and the travel 210 of such a particle between five points 215 observed successively over time (every 200 ms). As can be seen, the particle moves towards the cold zone of the chamber 110.

In the case of the embodiment illustrated in FIG. 1, the velocity of drainage of the continuous phase was measured at between 0.7 and 2.6 mm.s⁻¹ for temperature gradients of between 2.2 and 7.0 K.mm⁻¹.

FIG. 3a shows a curve 255 representing the average dimensionless temperature gradient (made dimensionless by the temperature gradient obtained at the stationary state) along the chamber 110 as a function of time. FIG. 3b shows a curve 260 representing a dimensionless temperature profiles (made dimensionless by the maximum temperature) as a function of the longitudinal axis of the chamber 110.

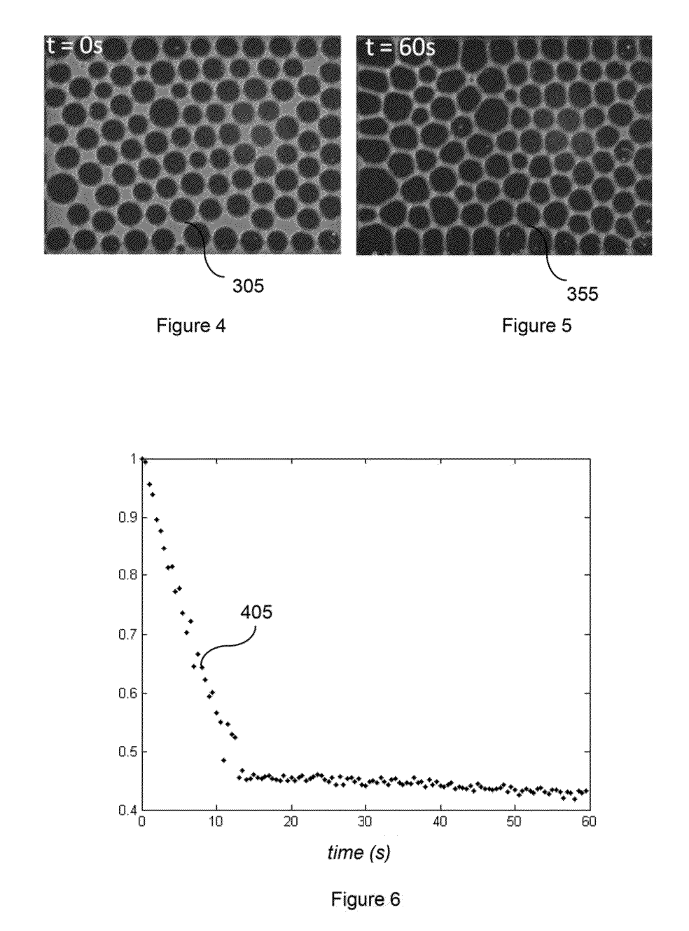

FIG. 4 represents a foam geometry 305 before powering up the resistors 155. The liquid phase is shown as light, whereas the bubbles making up the form are black. FIG. 5 represents a geometry 355 of the same foam after the resistors 155 have been supplied with electricity for 60 seconds, with a temperature gradient of 2.2 K/mm for a chamber cavity 2.5 mm long, 1.5 mm wide and 28 microns thick.

Because there is no liquid tank upstream from the chamber 110, the continuous phase extracted from the cavity by the drainage is not regenerated. The comparison between FIGS. 4 and 5 shows that the liquid fraction decreases significantly over time.

In the embodiment of FIG. 1, for a foam of FIG. 4 having an initial fraction of 35% by volume, it is possible to drain over 70% of the continuous phase in under 30 seconds for a temperature gradient of 7.0 K/mm. FIG. 6 shows a normalized curve 405 of the change in the liquid fraction over time (liquid fraction at instant t/initial liquid fraction). It can be seen that, in the specified embodiment, the liquid fraction decreases exponentially during the first 10 seconds.

Feature 7 shows a curve 455 of the change in the number of bubbles in the chamber 110, over time for a 7 K/mm temperature gradient. It can be seen that above 60 seconds, the number of bubbles in the cavity decreases drastically over time, which is a sign of the ripening of the foam by diffusion of gas through the films.

Work on the ripening of a foam in a Hele-Shaw cavity has already been carried out (J. Marchalot et al., EPL 83, 64006 (2008)); this shows that the number of bubbles inside the cavity is inversely proportional to the duration of the experiment. When the foam is subjected to a temperature gradient, which induces flowing of the external phase, the number of bubbles appears to decrease linearly over time. Applying a temperature gradient thus appears to have an influence over the ripening dynamic of the foam.

In this way, the present invention also has applications in the ripening of foam by application of a temperature gradient.

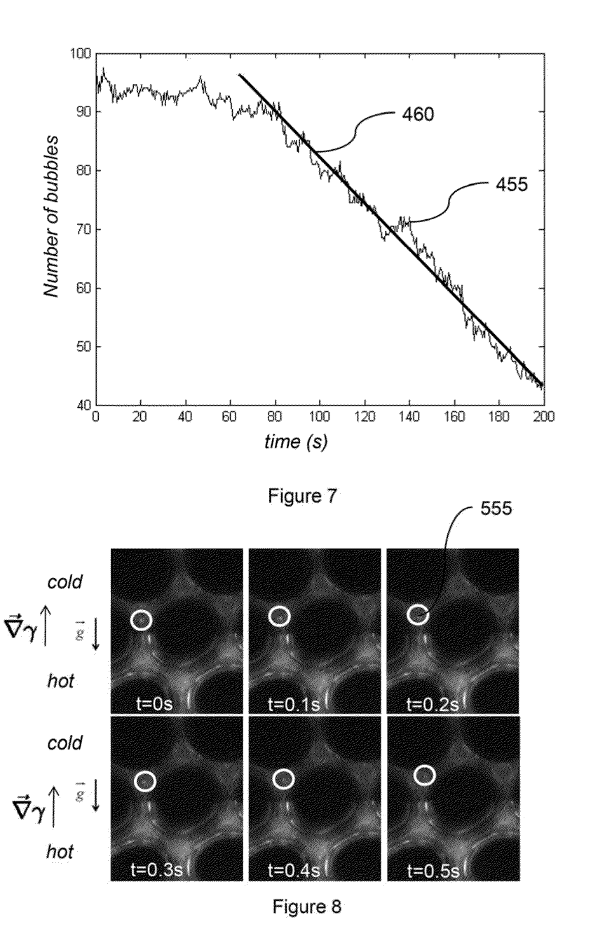

FIG. 7 shows, in particular, a relatively linear average slope 460 of decrease in the number of bubbles in the chamber.

The inventors have determined that a calculation using scaling laws in the case where the cavity is positioned vertically shows that the tangential stress induced by the application of a temperature gradient is of the same order of magnitude as the hydrostatic pressure that applies to a single bubble.

The present invention can therefore be utilized so that the thermocapillary effect slows or even stops or counteracts the volumetric force from gravity. In this way, the present invention can be used to homogenize the foam during its hardening, by counteracting the effect of the gravity drainage or, on the contrary, to destabilize it more quickly, by boosting the effect of the gravity drainage.

FIG. 8 shows, in a vertically-oriented cavity with its less-heated portion uppermost, the successive positions 555 of a control particle of the drainage. The vector g indicates the direction of gravity and the vector [symbol] indicates the direction of the tangential stress and therefore of pumping of the liquid.

FIG. 8 shows that, in a context where gravity drainage occurs, it can be counteracted thanks to thermocapillary pumping.

It can be seen that this particle moves vertically from bottom to top, showing that the gravity drainage can be inverted, with a velocity of about 110 μm/s, or lessened or canceled out for weaker temperature gradients.

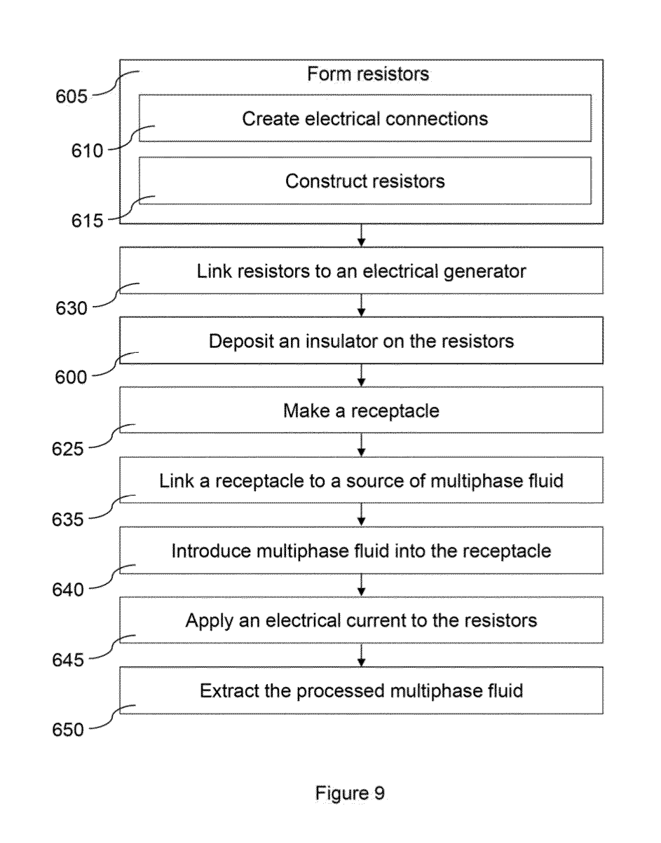

FIG. 9 represents steps in a particular embodiment of the device that is the subject of the present invention and of its operation.

During a step 605, at least one resistor 615 is formed on at least one wall, as well as at least one electrical connection 610 to connect the resistors to a power supply. For example, each resistor and electrical connection is formed by lithography, in which the resistors are produced by evaporation of chromium (15 nm, heating resistor) and the electrical connections are made of gold (150 nm, conductive resistor) on a wafer, then etched by using a photosensitive resin S1818 after an exposure to ultraviolet light through a mask.

The etching comprises a step 610 of creating a connection between the heating resistors and the current generator (made of gold: high electrical conductivity with a negligible Joule effect) and a step 615 of constructing the optimized resistors in chromium.

During a step 630, a current generator is connected to the connectors.

During a step 600, a fine insulating coating, e.g. 40-micron-thick PDMS, is deposited on a wall intended to form the chamber.

During a step 625, a Hele-Shaw cavity is made of PDMS, for example 45 microns high, 1.5 mm wide and 2.5 mm long, is formed by sealing each wall carrying at least one resistor, for example by using an air or oxygen plasma. The chamber is formed in this way. During a step 635, the chamber is connected to a source of multiphase fluid.

During a step 640, multiphase fluid is introduced into or generated in the chamber. During a step 645 an electrical current is applied through each resistor formed on a wall of the chamber, to form a temperature gradient inside the chamber.

After a predefined duration, the multiphase fluid is extracted during a step 650. It should be noted that during the extraction step, one can extract only the residual multiphase fluid, after drainage, or only the continuous phase, or a combination of the two or of the liquid provided from the outside into the multiphase fluid, for example to humidify it (increase the liquid fraction, in the case of foams), by means of a liquid tank positioned upstream.

The present invention applies particularly to the control of:
manufacturing metal/solid foams (e.g. polyurethane);
manufacturing food foams;
manufacturing silica foams;
manufacturing cosmetics and cleaning products;
enhanced oil recovery;
wastewater treatment; and
manufacturing phononic materials.

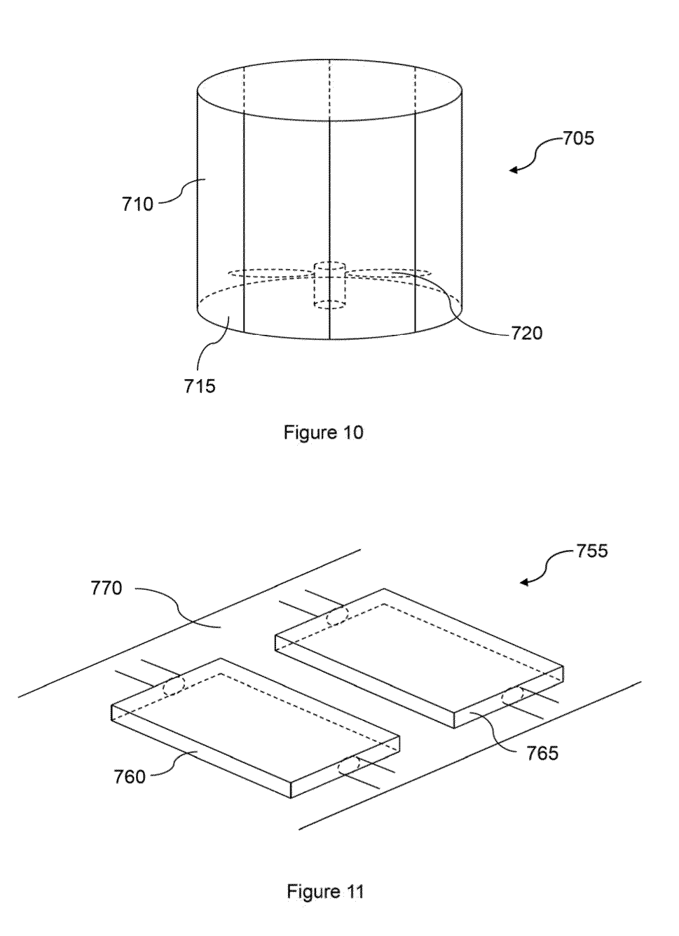

FIG. 10 shows a particular embodiment, in a three dimensional foam, of the device that is the subject of the present invention. This device 705 comprises a tank, cylindrical in this case, provided with lateral heating means 710 and a lower heating means 715, which jointly apply a vertical temperature gradient to the multiphase fluid contained in the vat. Means for generating this multiphase fluid 720 is provided at the bottom of the vat. This generating means 720 is represented here as a set of two blades applying a shearing to generate a multiphase fluid.

FIG. 11 shows a particular embodiment of the device that is the subject of this invention, applied to a production line for solid foam or for a solid containing gas inclusions. The device 755 comprises, on a conveyor 770, a device 760 and a device 765 similar to the one shown in FIG. 1, possibly at a different scale. The device 760 applies a temperature gradient to the multiphase fluid it contains to move at least one of the two phases. Once the pumping has been carried out, the device 760 is moved by the conveyor 770 to the position of the device 765. In this position, the purpose of the device 765 is to solidify the multiphase fluid it contains, for example by increasing or decreasing the temperature. At the next position, not shown, the residual multiphase system is extracted, in this case solidified foam or solid matter containing gas inclusions, by opening the device and demolding the foam.

The temperature gradient being a relative value, in other embodiments, the temperature gradient is maintained during the solidification of the foam. In these embodiments, the average temperature increases or decreases but the temperature gradient is maintained, making it possible to maintain the effect of the thermocapillary drainage during the solidification of the foam.

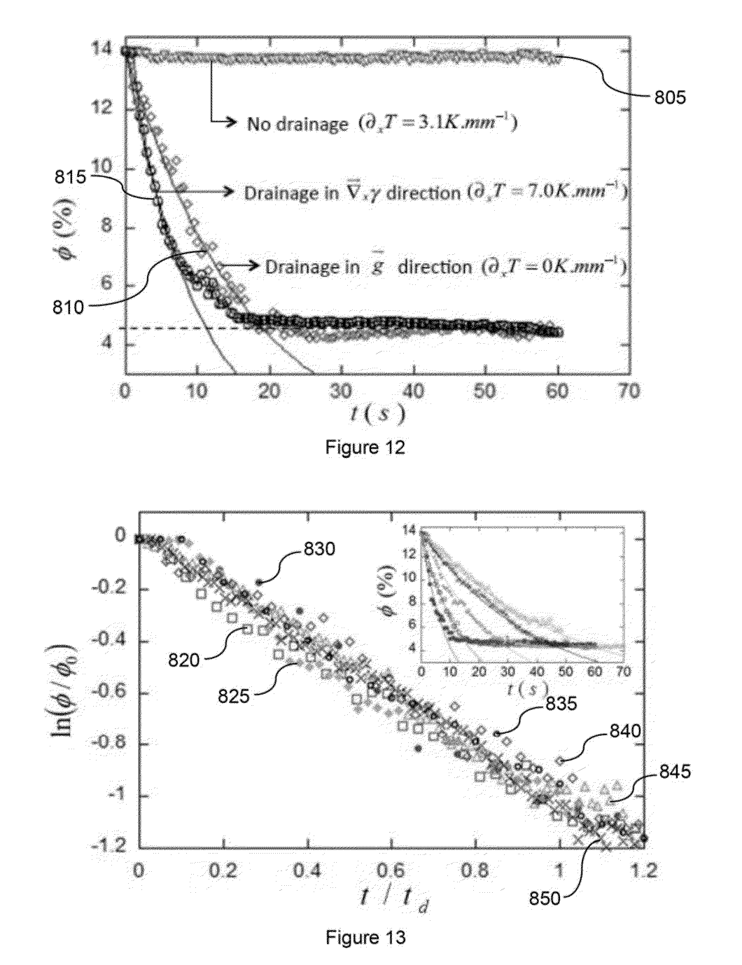

FIG. 12 shows the percentage change in the liquid fraction over time for various temperature gradients, for a vertical chamber. The triangles that make up the curve 805 show that the gravity drainage can be stopped when the temperature gradient exerts an upward force, which counteracts the force of gravity. The diamond shapes that make up the curve 810 show the effect of gravity alone, absent any temperature gradient. Lastly, the circles that make up the curve 815 show the antagonistic effect of gravity and of the temperature gradient when the latter dominates the former, leading to a bottom-up drainage.

A model is given below that makes it possible to forecast the changes in the liquid fraction as a function of time. Gravity and the interface stress, defined by dγ/dx (surface tension changes along the cavity), are taken into account. The exponents th and g refer, respectively, to the thermocapillary and gravity contributions. The only adjustable parameters are α and β, which can be likened to porosity/permeability.

Mass conservation is expressed thus:

d(ewLφ)/dt=±(Q^{th}+Q^{g})

where e is the thickness of the cavity, w is its width and L is its length. φ is the continuous phase fraction. Q is the pumped phase flow, the indices th and g refer, respectively, to the thermocapillary and gravity contributions.

The contributions to the velocity of the liquid in a section (yz) is expressed thus:

vₓ^{-th}=α dₓγ e/η and vₓ^{-g}=−β ρ g e²/η

i.e.

Q^{-th}=vₓ^{-th}ewφ and Q^{-g}=vₓ^{-g}ewφ

From which is obtained ln(φ/φ₀)=−|1/t_{d}^{th}−1/t_{d}^{g}|t

where

t_{d}^{th}=ηL/(α dₓ γ e) and t_{d}^{g}=ηL/(β ρ g e²)

where η is the viscosity of the continuous phase, ρ is its density and φ₀ is the initial continuous phase fraction. vₓ is the velocity projected in the cavity's longitudinal direction, t_{d} is the typical drainage time; in both cases, the indices th and g refer, respectively to the thermocapillary and gravity contributions.

FIG. 13 shows that the model perfectly reproduces the experimental results. Irrespective of the experiments, the values of α and β are identical (α=3.7 10⁻³ and β=4.7 10⁻³). This demonstrates the robustness of the model expressed above.

In this way, a typical drainage characteristic t_{d} is defined:

ln(φ/φ₀)=−|1/t_{d}^{th}−1/t_{d}^{g}|t=t/t_{d}

The figure represents, successively, experiments conducted horizontally for a temperature gradient of: 1 K.mm⁻¹ represented by the hollow triangles 845; 1.2 K.mm⁻¹ represented by the crosses 850; 2.2 K.mm⁻¹ represented by the filled diamonds 825; 3.5 K.mm⁻¹ represented by the hollow squares 820; 7 K.mm⁻¹ represented by the filled circles 830. Experiments with gravity only are represented by hollow diamond shapes 840 and experiments conducted with gravity and a temperature gradient of 7 K.mm⁻¹ are represented by the hollow circles 835.

Two tables are shown below wherein the geometric and physicochemical (other surfactant) parameters have been changed. It can be seen that substantially the same values for α and β are always obtained.

| L | e | | | | ∂ₓT | t_{d}^{th} | |
|---|---|---|---|---|---|---|---|
| (mm) | (μm) | L/e | surf. | g̅ | (K · mm⁻¹) | (s) | α × 10³ |
| 2.0 | 54.5 | 36.7 | SDS | Ø | 1.0 | 54.3 | 3.7 |
| 2.0 | 54.5 | 36.7 | ″ | Ø | 1.2 | 45.3 | 3.7 |
| 2.0 | 54.5 | 36.7 | ″ | Ø | 2.2 | 24.6 | 3.7 |
| 2.0 | 54.5 | 36.7 | ″ | Ø | 3.5 | 15.5 | 3.7 |
| 2.0 | 54.5 | 36.7 | ″ | Ø | 7.0 | 7.8 | 3.7 |
| 2.0 | 54.5 | 36.7 | ″ | + | 2.1 | 25.1 | 3.8 |
| 2.0 | 54.5 | 36.7 | ″ | + | 5.5 | 9.9 | 3.7 |
| 2.0 | 54.5 | 36.7 | ″ | + | 7.0 | 7.8 | 3.7 |
| 2.5 | 32.0 | 78.1 | ″ | Ø | 3.5 | 32.2 | 3.8 |
| 2.5 | 32.0 | 78.1 | ″ | Ø | 7.0 | 16.5 | 3.7 |
| 2.0 | 54.5 | 36.7 | C₁₂TAB | Ø | 7.0 | 13.8 | 3.7 |

Table above: Dimensionless permeability α obtained by causing the experiment's parameters to vary.

| L (mm) | e (μm) | L/e² × 10⁶ | t_{d}^{g} (s) | β × 10³ |
|---|---|---|---|---|
| 2.0 | 54.5 | 0.67 | 19.8 | 4.8 |
| 2.5 | 54.5 | 0.84 | 25.5 | 4.6 |
| 2.0 | 40.2 | 1.24 | 29.5 | 4.9 |

Table above: Dimensionless permeability β obtained by causing the cell's geometric parameters to vary.

In each of the embodiments, means of extraction (not shown) of the multiphase fluid is utilized, which extracts either the multiphase fluid after moving at least partially at least one of its phases, or a multiphase system comprising at least one solid phase, according to the application of the present invention.

In some embodiments, the means 155, 710, 715 for generating a temperature gradient along the chamber to cause a displacement of at least one of the phases of the multiphase fluid is configured to remove from the chamber at least half of one of the phases of the multiphase fluid.

In some embodiments, the means 155, 710, 715 for generating a temperature gradient along the chamber to cause a displacement of at least one of the phases of the multiphase fluid is configured to homogenize, within the chamber, the distribution of the phases of the multiphase fluid.

In some embodiments, the means for generating a temperature gradient along the chamber to cause a displacement of at least one of the phases of the multiphase fluid is configured to humidify the multiphase fluid by increasing the proportion of liquid, in the case of foams, from a tank positioned upstream.

The dimensions and characteristics of the implementation device shown are not restrictive. The dimensions of the device can be adjusting according to the target application, in terms of the size of the chamber and of the heating resistors. Similarly, the material the chamber is made of must be suitable for the application envisaged, depending on, for example, its thermomechanical or chemical resilience. All techniques for generating a temperature gradient are suitable; in particular, the following can be cited, in addition to the Joule effect: microwaves, using infrareds, solar storage, induction or heating by means of a laser. In the case of Joule effect heating resistors, all conductive materials can be used in addition to chromium. Lastly, the invention can be applied to all multiphase fluids consisting of at least two immiscible phases.

It should be noted the multiphase fluid can be generated outside the chamber, as illustrated in FIG. 1, then introduced into the chamber, or it can also be generated within the chamber, as illustrated in FIG. 10, by mechanical, chemical or physical means.

Readers may refer to known techniques of in situ foaming. According to a first example, a chamber containing liquid, gas (in separate phases) and a solid object, is simply shaken, making it possible to generate the foam. According to a second example, a solid object is inserted into a chamber filled with liquid and gas, and the chamber is subjected to a rotation, enabling the generation of foams. In industrial processes, such as forming metal foams (J. Dairon, Les mousses métalliques [“Metal foams”], 2009, Editions Techniques des Industries de la Fonderie), there are many techniques for foaming. There is a large number of applications of solid foams in the manufacturing sector. There are various methods of producing such foams. Some techniques utilize molten metals whose viscosity has been adjusted. Foams can be formed from such molten metals, e.g. by injecting therein gas or foaming agents able to release gas, which creates bubbles during their decomposition in situ. An alternative method consists of preparing oversaturated metal-gas systems under high pressure and initiating bubble formation by controlling the pressure or the temperature. Lastly, metal foams can be formed by mixing a metal powder with a foaming agent then, after compression, by causing the mixture to foam by melting the compact mixture. The direct foaming process makes it possible to produce a large volume of low-density foam. In addition, these foams will certainly be cheaper than those produced from cellular metal materials.

It is also possible to achieve foaming by bubbling (an end-fitting is placed at one extremity of a chamber containing liquid and gas, through which gas is injected). In the case of glassmakers, the glass foam appears “spontaneously” when the silica has melted.

The above description illustrates the implementation of the present invention on multiphase fluids made of foams. However, the present invention is also applicable to “bubbly liquid” types of multiphase fluids. Indeed, the foams form a “compact” network of bubbles, but some applications (or development of materials) require that inclusions (gas cavities) be introduced within the material. Elastomers can be mentioned, such as those used for manufacturing coatings. In this case, the present invention is applied to achieve a more homogenous distribution of the inclusions within the matrix by thermocapillary transport of the inclusions. The difference between this and foams is that the bubbles can move within the bubbly liquid. The tangential stress made by the device induces a flow of the external phase to the bubbles and, by conservation of mass, the bubbles move towards the hottest portion of the liquid, where the surface tension is lowest, in other words, where each bubble's interface energy is lowest. In the case where the surface tension change with temperature is of the opposite sign to the previous case, (interfacial energy lower in the coldest areas) the migration is in the opposite direction.

The present invention is also applicable to setting into motion within a multiphase fluid comprising a liquid instead of the gas in the two configurations mentioned; either the continuous phase is set into motion (compact network of drops), or the drops are individually moved (no contact between adjacent drops).

The present invention is also applicable to manufacturing materials involving drying dynamics within their manufacturing process (e.g. for structuring deposits of nanoparticles in menisci in the case of polymer materials for flexible electronics) or to manufacture new intelligent materials having a hydrodynamic response to an electrically-controlled thermal action.

It should be noted that, for generating a temperature gradient, resistors on both sides of the chamber can be utilized.

In large-scale applications, the temperature gradient can be generated on the edges of the chamber via various techniques for heating (Joule effect, pre-heated fluids, microwaves, etc.). The difference between this and what is described with regard to FIGS. 1 to 7 is the transition time for establishing the temperature gradient. For example, on a one-meter scale, several tens of minutes will be required for a conventional material (conductive metals such as copper).

It should be noted that the interface is set into motion by the temperature gradient relative to the bubble's center of mass.

1-12. (canceled)

13. Device for configuring a multiphase fluid consisting of at least two immiscible phases on either side of separation surfaces, comprising:
a chamber to contain the multiphase fluid;
a heating element to generate a temperature gradient along the chamber to vary a surface tension of the separation surfaces along the chamber and to cause at least one immiscible phase of the multiphase fluid to move; and
an extractor to extract at least one movable immiscible phase of the multiphase fluid.

14. Device according to claim 13, wherein the heating element comprises at least one electrical resistor formed on a surface of the chamber to provide a variable heat density along a wall of the chamber.

15. Device according to claim 13, further comprising a flow device configured to generate the multiphase fluid upstream from the chamber.

16. Device according to claim 13, further comprising a flow device to generate the multiphase fluid inside the chamber.

17. Device according to claim 16, wherein the multiphase fluid comprises a foam.

18. Device according to claim 16, wherein the multiphase fluid comprises a bubbly liquid.

19. Device according to claim 16, wherein the multiphase fluid comprises an emulsion.

20. Device according to claim 13, further comprising a solidifier to solidify the multiphase fluid.

21. Device according to claim 13, wherein the heating element generating the temperature gradient along the chamber to cause a displacement of said at least one of the immiscible phases of the multiphase fluid is configured to remove from the chamber at least half of said at least one of the immiscible phases of the multiphase fluid.

22. Device according to claim 13, wherein the heating element generating the temperature gradient along the chamber to cause a displacement of said at least one of the immiscible phases of the multiphase fluid is configured to homogenize, within the chamber, a distribution of the immiscible phases of the multiphase fluid.

23. Device according to claim 13, wherein the heating element generating the temperature gradient along the chamber to cause a displacement of said at least one of the immiscible phases of the multiphase fluid is configured to humidify the multiphase fluid by increasing a proportion of liquid from a tank positioned upstream.

24. Device according to claim 23, wherein the multiphase fluid comprises a foam.

25. Method for configuring a multiphase fluid consisting of at least two immiscible phases on either side of separation surfaces, comprising the steps of:
forming a chamber full of multiphase fluid;
generating a temperature gradient along the chamber to vary a surface tension of the separation surfaces along the chamber and to cause at least one immiscible phase of the multiphase fluid to move; and
extracting at least one moveable immiscible phases of the multiphase fluid.
